(19) United States
(12) Patent Application Publication
(10) Pub. No.: US 2026/0266699 A1
(43) Pub. Date: Sep. 10, 2026

(54) A SORBENT DEVICE FOR SORPTIVE SAMPLING

(71) Applicant: MARKES INTERNATIONAL LIMITED, Bridgend (GB)

(72) Inventors: Nicholas P BUKOWSKI, Bridgend (GB); Stephen SMITH, Bridgend (GB); Jonathan P WILLIAMS, Bridgend (GB); Joshua MARSHALL, Bridgend (GB); Napoleon COVERDALE, Bridgend (GB); Alun COLE, Bridgend (GB); Jeffrey WILLIAMS, Bridgend (GB); Robert J GREEN, Bridgend (GB)

(73) Assignee: MARKES INTERNATIONAL LIMITED, Bridgend (GB)

(21) Appl. No.: 19/166,428

(22) PCT Filed: Mar. 19, 2024
(86) PCT No.: PCT/GB2024/050742

§ 371 Date: Sep. 17, 2025

(30) Foreign Application Priority Data
Mar. 20, 2023 (GB) 2304033.0

(51) Int. Cl. G01N 1/12; B01D 15/22; B01J 20/28; G01N 1/22

(52) U.S. Cl. CPC G01N 1/12; B01D 15/22; B01J 20/28052; G01N 1/22

(57) ABSTRACT

A sorbent sleeve for a sorbent sample probe comprises a hollow cylindrical body that receives a probe shaft. The body has a laminate structure formed from a plurality of layers of sorbent material. The layers may be formed of different sorbent materials. The sleeve is formed by from one or more sheets of sorbent material that are cut to form a plurality of sorbent elements. The sorbent elements are assembled to form a laminate structure having a series of layers defined by the plurality of sorbent elements.

### FIELD OF INVENTION

The present disclosure relates to a sorbent device for the sorbent sampling of liquids and gases. In particular, the present disclosure relates to a sorbent device for a sampling probe for use in automated sorbent sampling.

### BACKGROUND

Sampling techniques are frequently utilised to identify components of interest (analytes) within a sample; such as pollutants in drinking water, fragrance allergens in cosmetics or flavour profiling of beverages. The analysis of such samples may involve liquid-liquid extraction (LLE) or solid phase extraction (SPE).

In solid phase extraction a sorptive material (a sorbent) is placed into a liquid sample and the sorbent extracts analytes contained therein by sorption (i.e., adsorption onto the surface, or absorption into the sorbent's volume). The quantity of analyte extracted is proportional to its concentration in the sample, providing equilibrium is reached. The amount of analyte extracted can also be dependent on the quantity of sorbent used and hence maximising the volume of the sorbent can be desirable.

Solid Phase MicroExtraction (SPME) is a known SPE sampling technique for extracting organic compounds from a sample, which has found widespread use due to its applicability to automation. The ability to automate as much of the extraction process as possible is desirable as it reduces costs and user error, and becomes a scalable lab operation. A known SPME technique involves the use of probes having a sorbent material covering a cylindrical part of the probe body. The sorbent material is typically chemically bonded to the support element of the probe. This requires a sorbent material that can be treated to bond the material to the probe, thereby limiting the range of sorbent materials available and hence the application of the probe. Furthermore, the bonding region between the sorbent material and the probe is limited to a very narrow layer of material in immediate contact with the probe. The remainder of the sorbent material is subject to shear forces and the thickness of the film must therefore be minimised to limit the impact of the shear forces on the integrity of the sorbent material. Consequently, the analyte capacity of the sorbent material is limited, which in turn limits the sensitivity of the measurement.

To address these limitations it is known to apply sorbent material to a probe in the form of a cylindrical sleeves that are held in place by compression or other mechanical means. This improves robustness and so enables a greater amount of sorbent to be used, thereby increasing the uptake of analytes and hence sensitivity of analysis. However, the use of sorbent sleeves presents several challenges.

Sorbent sleeves are generally produced as tubes formed by extrusion of sorbent material. While extrusion can be used to produce large quantities of extrudant at competitive prices it requires a significant amount of material to begin production of high-quality extrudant. Consequently, when producing the relatively small lengths required for sorbent probes the economies of scale are prohibitive and the amount of wasted material can end up being larger than intended product. This has led to the number of solid phases available for a tube format being limited to only a few stock materials. Bespoke material with particular affinity for certain analytes are not available in extruded form due to their specialised application and the relatively small amount of materials required for analytical extraction. The manufacture of such bespoke material in tube format requires substantial amount of material to warrant the process of drawing tubes, which given the relatively small amount of materials required for analytical extraction is prohibitively expensive and therefore not commercial viable.

Bespoke materials may be formed as films in limited batch sizes and of modest surface area. This is cost effective relevant to the quantities required for analytical extraction and the use of films as free form extraction devices is well known. However, while films are more easily constructed, having to make numerous films to reflect varying mixtures of material is prohibitive. Moreover, certain sorbent chemistries may be incompatible to form single sorbent sheets. As a result, the availability of film is limited to certain single sorbents or mixtures with a limited range of co-sorbent percentages, which limit the choice of affinities. Moreover, films are not readily amenable to use in automated sampling systems.

Further, it is sometimes desirable to analyse multiple analytes within a sample. Whilst this can potentially be achieved by a single sorbent, capable of capturing these target analytes, said single sorbent would likely capture unintended analytes in addition to those of interest. One process for which this is a challenge is Stir Bar Sorptive Extraction (SBSE), which relies on tubular sorbent structures. Therefore, when extracting multiple analytes in a single sample it is common to use multiple probes, each configured to capture specific target analytes, to ensure only specific analytes of interest are extracted. This inherently lengthens the quantity of probes required and by virtue of this increases not only the sampling duration but also the time required for subsequent post-processing.

It is therefore desirable to provide an improved sorbent device for a sorption probe, and/or a method of producing said sorbent device which addresses the above-described problems and/or which offers improvements generally.

### SUMMARY

According to the present disclosure there is provided a sorbent device for sorptive sampling as described in the accompanying claims.

In an aspect of the disclosure there is provided a sorbent device or sorbent element for sorptive sampling comprising a body having a laminate structure formed from a plurality of layers of sorbent material. Forming a laminate sorbent device from a plurality of layers advantageously enables the sorbent device to be formed from sheets of sorbent material, which are more economical to produce and allow a wider range of bespoke sorbent materials, rather than relying on a more limited range of stock extruded materials. Laminate extraction therefore combines the benefits of film over tubes in terms of manufacturing cost in a tubular format. The term ‘sorbent’ refers to any substance which has the property of collecting molecules of another substance by sorption. The term sorption covers both absorption and adsorption. The term laminate refers to a plurality of layers that are arranged to form a laminate structure, where each layer is coincident to at least one other layer. The term laminate relates only to the layered structure and should not be construed to be indicative of the boundary conditions between said layers (e.g. bonded/not bonded).

The body may be elongate having a width and a longitudinal axis and the plurality of layers are axially arranged. That is to say, they are arranged in an axial stack, with the upper and lower surface of each layer extending radially. Each layer is formed as a disc.

The elongate body may be cylindrical. The term ‘cylindrical’ is not limited to shapes having a circular cross section and may comprise any elongate 3-dimensional form with a constant cross section.

The body may comprise an axially extending bore for receiving the shaft of a probe, with the sorbent device functioning as a sleeve that is received around the shaft.

One or more of the plurality of layers may be formed from a sorbent material that is different to the sorbent material of one of more of the other plurality of layers. The laminate sorbent device is therefore formed of a plurality of sorbent materials having varying affinities. In this way, the sorbent device can sample a wide range of analytes (e.g. of differing chemical type and differing volatiles) due to the multiple layers of different sorbent material. Beneficially this allows a single probe to sample multiple analytes in a targeted manner. This reduces the number of probes required and reduces sampling duration and the required quantity of post-processing treatment of the probes. This has benefits for automation in that it eases the challenge of programming the sorption process and reduces the number of components that need to be automated. The laminate sorbent tube enables a greater choice of co-sorbent for extraction, with the sorbent properties being readily adjustable by varying the composition of the laminate. At the same time, the tube structure of the sorbent material remains suitable for use on an automated probe, enabling the benefits of automated sampling to be retained. While the use of films to form the laminates is beneficial, the disclosure is not restricted to films for source of laminate and in certain circumstances tubes may be used as a source of some or all of the laminates.

Each layer may comprise a disc formed of sorbent material. Each disc may include an aperture, with the apertures of the assembled discs forming a bore through the sorbent device.

Each layer may have a height along its axial length that is equal to or less than its diameter.

In another aspect of the disclosure there is provided a sorbent probe comprising a shaft and a sorbent device as described above that is secured to said shaft.

The sorbent device may be formed as a sleeve having an axially extending bore and the sleeve is received around a portion of the shaft. It will be appreciated that the term ‘sleeve’ is made with consideration of the plurality of layers, in that the ‘sleeve’ is made up of the plurality of layers, where ‘sleeve’ is used only to define the combined shape of the plurality of layers.

The sorbent device has axially opposed first and second ends and the sorbent probe comprises first and second clamping elements located respectively at the first and second ends of the sorbent device operative to clamp and axially compress the plurality of layers of the sorbent device.

The probe may include a piercing tip having a first outer diameter and the sorbent device has a second outer diameter that is less than or equal to the first diameter. In this way the outer surface is axially shielded by the tip, which pierces an aperture in the septum of a sampling vial that the sleeve is able to pass through without significant contact, thereby protecting the sorbent sleeve from undue wear and damage.

In another aspect of the disclosure there is provided a method of forming a sorbent device comprising:
providing one or more sheets of sorbent material;
cutting a plurality of sorbent elements from said one or more sheets of sorbent material;
assembling said plurality of sorbent elements to form a laminate structure having a series of layers defined by said plurality of sorbent elements.

Each of said sorbent elements preferably has the same cross-sectional shape. As such, when the elements are stacked they form an elongate three dimensional object of constant cross section.

Each of said sorbent elements may be annular and the plurality of sorbent elements are assembled to form a cylinder having an axially extending bore.

The plurality of sorbent elements may be formed from a plurality of sheets of sorbent material and one or more of the plurality of sheets is formed from a sorbent material that is different to the sorbent material of one of more of the other plurality of sheets, and the sorbent elements are assembled such that one or more of the plurality of sorbent elements is formed from a sorbent material that is different to the sorbent material of one of more of the other plurality of sorbent elements. In this way the sorbent properties of the sorbent device may be selectively tailored to a specific range of target analytes, that may be sampled by one probe rather than requiring multiple probes and multiple analyses.

The plurality of sorbent elements may be cut from the one or more sorbent sheets by a punching operation. The sorbent elements may include an outer diameter and an inner diameter forming said bore and the punching operation may be a two-stage process in which the outer diameter is formed in one step and the inner diameter is formed in another step.

In another aspect of the disclosure a method of forming a sorbent sampling probe comprises:

forming a plurality of sorbent elements according to the above described method;

inserting said plurality of sorbent elements onto a shaft of a sample probe having a longitudinal axis to form a laminate sleeve; and
securing said sorbent elements on said shaft.

The method may further comprise applying an axially compressive force to the sleeve to clamp the sorbent elements together and secure them on the shaft. The probe may comprise a shaft formed of two or more parts and two of the parts may be separable and include first and second clamping surfaces. The sorbent elements are inserted onto one of the two part and the two parts are then secured together, such as by a thread connection, to axially compress the sorbent elements between the first and second clamping surfaces.

The method may further comprise selecting a plurality of sorbent elements formed of different sorbent materials selected based on target analytes, and inserting the selected sorbent elements onto the probe.

In another aspect of the disclosure there is provided a method of sorptive sampling comprising providing a probe carrying a sorptive sampling formed of a plurality of sorbent materials selected based on a plurality of target and inserting said probe into a sample to acquire said analytes.

In an aspect of the disclosure there is provided a sample probe for sorptive sampling comprising an elongate body having a longitudinal axis defined along its length and a radial axis extending transverse to the longitudinal axis. A sorbent element/device as described above has a longitudinal axis defined along its length where said longitudinal axis defines the ends of the sorbent element, and where the sorbent element also comprises a bore defined along its longitudinal axis. The elongate body has an outer surface and a recess located along the length of the body that extends radially into the outer surface. The sorbent element is at least partially received within the recess of the body, such that the bore passes over the recess. Locating at least part of the sorbent element within the radial recess mechanically locks the sorbent element to the body to prevent relative longitudinal movement of the sorbent sleeve relative to the body. This advantageously obviates the requirement to rely exclusively on chemical bonding to secure the sorbent to the body, which has been found to be difficult to achieve, and ensures that the sorbent element is not able to be dragged off the body by a septum or otherwise in use.

The body of the sampling probe may include a shaft, a first part of greater diameter than the shaft and a second part of greater diameter than the shaft, where said first and second parts are located at either end of said shaft. The sorbent element may be a sleeve that is received around the shaft. The sleeve may be an independent component that is able to be inserted onto the shaft. Alternatively, the sleeve may be a layer of material that is deposited onto or otherwise formed onto and/or bonded to the shaft. The first and second parts of greater diameter can also collectively be referred to as the enlarged diameter sections. The difference in diameter between the shaft and the enlarged diameter sections may define the recess in which the sorbent element is received.

Each enlarged diameter section may have opposing inner ends or faces which face towards the shaft in the longitudinal direction. Each inner face may include a longitudinally extending recess arranged to receive an end of the sorbent sleeve such that the sleeve is both radially and longitudinally constrained by the enlarged diameter sections.

A longitudinally extending recess may be provided for each enlarged diameter section which may include an inner wall and an outer wall in the radial direction where the ends of the sleeve are located between the inner and outer walls of each longitudinally extending recess, thereby radially constraining the sleeve at both ends.

The sorbent sleeve may be longitudinally clamped between enlarged diameter sections such that the entire sorbent sleeve is longitudinally located between the enlarged diameter sections.

The sorbent sleeve may be a sorbent sleeve as described above.

The sorbent sleeve may have an outer diameter equal to or less than the diameter of each enlarged diameter section. Beneficially this result in the radially exterior surface of the sleeve being located flush with or recessed radially inwards of the radially exterior surfaces of the enlarged diameter sections. Beneficial this results in the enlarged diameter sections shielding the sleeve when the probe passes through a sealing element.

Longitudinally extending recesses may be provided in the enlarged diameter sections which may be annular such that they receive the ends of the sleeve around their entire circumference.

At least one longitudinally extending recess may be provided in the enlarged diameter sections, where the outer wall of each longitudinally extending recess may taper radially inwards in the longitudinal direction away from the inner face of the enlarged diameter sections. The tapering of the longitudinally extending recess provides radial constriction of the end parts of the sleeve between the radial inner and outer walls of the recess to clamp the end parts and create a seal between the enlarged diameter sections and the sleeve. The sealing of the sleeve at either end advantageously prevents liquid ingress into the sleeve between the sleeve and the shaft. If liquid ingress is not prevented, it can be challenging to remove liquid ingress, which can cause carry-over of a previous sample into the subsequent sample, thereby impacting results.

An inner wall of the longitudinally extending recess may have a diameter that is continuous with the diameter of the shaft such that the shaft is able to be received within the bore of the sleeve. The outer wall of the longitudinally extending recess may taper radially inwards in the longitudinal direction towards the inner wall of the longitudinally extending recess.

At least one of the enlarged diameter end sections may be releasably connected to the shaft.

At least one of the enlarged diameter end sections may be secured to the shaft by a threaded connection. The at least one enlarged diameter section may include a threaded bore and the end of the shaft includes a threaded connector section, where the threaded bore engages with the threaded connector section, forming a threaded connection. Beneficially, a threaded connection allows the shaft to be disconnected from one of the enlarged diameter end sections. This beneficially enables the sleeve to be inserted onto the shaft before the shaft is connected to the enlarged diameter section by means of the threaded connection.

The sorbent sleeve may have a length that may be selected such that it corresponds to the length of the shaft and both longitudinally extending recesses of the enlarged diameter sections, where the length of the shaft does not include at least the length of the threaded connector section. Beneficially, this selection results in the sleeve being longitudinally received within the longitudinally extending recesses as the shaft is threaded into the enlarged diameter section. The enlarge diameter sections may move towards each other as threaded connection continues and the ends of the sleeve may be clamped between the two end sections in the longitudinal direction, and between the inner and outer walls of the recesses in the radial direction.

The first enlarged diameter end section preferably includes a tapered tip at its outer, distal end to assist insertion of the probe into a sample vessel. The first enlarged diameter end section and the shaft are preferably integrally formed as a unitary component.

The second enlarged diameter end section includes a connection portion at its distal end, being the opposite end to the inner face, the connection portion being configured to allow the probe to be connected to by an actuator such as a robotic arm or for manual use.

The elongate body preferably comprises at least one channel formed in the surface thereof, the channel defining said recess. The sorbent material is provided within the channel such that an outer surface of the sorbent material is exposed. The sorbent material may be moulded, adhered or secured into the channel by any suitable means.

The body of the sample probe preferably has an outer surface, and the sorbent material is preferably recessed within the body such that the exposed outer surface of the sorbent material does not extend radially outwards of the outer surface of the body. Keeping the sorbent material flush with or recessed beneath the outer surface of the probe prevents significant contact with the sorbent material.

The body may include at least two longitudinally extending channels arranged on diametrically opposed sides of the body, each channel containing sorbent material.

The channels are preferably longitudinally extending and longitudinally aligned.

The body of the probe may include a tip section and a stem section which are detachably connected, and the sorbent material is provided on the tip section. This enables the sorbent material to be periodically replaced through replacement of the tip section without the requirement to replace the entire probe.

The distal end of the tip section may have a first diameter and the proximal end has a second diameter that is preferably greater than the first diameter. A tapered section interconnects the first and second diameter sections, the sorbent material being located on the first diameter section. The majority of the force in piercing and sealing against the septum is therefore borne by the wider diameter section, limiting the shear forces on the tip section.

The shaft may include a further recess arranged to receive a marker element carrying a barcode or other indicia. The recess comprises a region of reduced diameter that ensures the indicia, which is preferably an adhesive strip secured around the circumference of the shaft, does not extend past the outer surface of the shaft preventing the strip from being damages or removed in use.

In another aspect of the invention there is provided a method of producing a sorbent sleeve for a sorbent probe. The sleeve is formed from one or more planar sheets of sorbent material. A plurality of round discs of material each having a central aperture are punched or otherwise cut from the planar sheets such rings of sorbent are produced. The discs may be assembled for form a laminated sleeve. The planar sheets of sorbent material are readily available and should a custom sorbent be desired, short runs of planar sorbent material can be produced economically with minimal wastage of material. Beneficially, this results in a wider range of sorbents being available to the user.

The sorbent materials described above may each comprise at least one material from the group comprising polyethylene glycol, silicone, octadecyltrichlorosilane, polymethylvinyl chlorosilane, liquid-crystalline polyacrylates, grafted self-organized monomolecular layers, graphene, carbon nanotubes, ionic liquids and inorganic coating materials.

Each of the sheets or films from which sorbent elements are formed may comprise a single material or may be a composite blend. One or more types of particulate sorbent may be mixed to high homogeneity in a resin type sorbent prior to thermal or catalyst activated curing of said composite.

### BRIEF DESCRIPTION OF THE DRAWINGS

The present disclosure will now be described by way of example only with reference to the following illustrative figures in which:

FIG. 1 shows a section view of a sampling probe according to an aspect of the disclosure;

FIG. 2 is a sectioned enlarged view of the lower portion of the sampling probe of FIG. 1;

FIG. 3 is a sectioned enlarged view of the lower portion of the sampling probe of FIG. 1;

FIG. 4 shows a section view of a sampling probe according to another aspect of the disclosure ;

FIG. 5 shows a section view of a sampling probe according to a further aspect of the disclosure ;

FIG. 6 is a section view of an apparatus for forming sorbent discs according an embodiment of the disclosure during a first cutting step;

FIG. 7 is a section view of the apparatus of FIG. 6 during a second cutting step; and

FIG. 8 is shows a sorbent sheet having sorbent discs punched according an embodiment of the disclosure during a first cutting step.

### DESCRIPTION OF EMBODIMENTS

The following description presents exemplary embodiments and, together with the drawings, serves to explain principles of the disclosure. The scope of the disclosure is not intended to be limited to the precise details of the embodiments or exact adherence with all method steps. Variations will be apparent to a skilled person and are deemed also to be covered by the description. Terms for features used herein should be given a broad interpretation that also encompasses equivalent functions and features. In some cases, several alternative terms (synonyms) for structural features have been provided but such terms are not intended to be exhaustive.

Descriptive terms should also be given the broadest possible interpretation; e.g. the term “comprising” as used in this specification means “consisting at least in part of” such that interpreting each statement in this specification that includes the term “comprising”, features other than that or those prefaced by the term may also be present. Related terms such as “comprise” and “comprises” are to be interpreted in the same manner. Directional terms such as “vertical”, “horizontal”, “up”, “down”, “upper” and “lower” are relative terms that may be used for convenience of explanation usually with reference to the illustrations and are not intended to be ultimately limiting if an equivalent function can be achieved with an alternative dimension and/or direction.

The description herein refers to embodiments with particular combinations of configuration steps or features. However, it is envisaged that further combinations and cross-combinations of compatible steps or features between embodiments will be possible. The description of multiple features in relation to any specific embodiment is not an indication that such features are inextricably linked, and isolated features may function independently from other features and not necessarily require implementation as a complete combination.

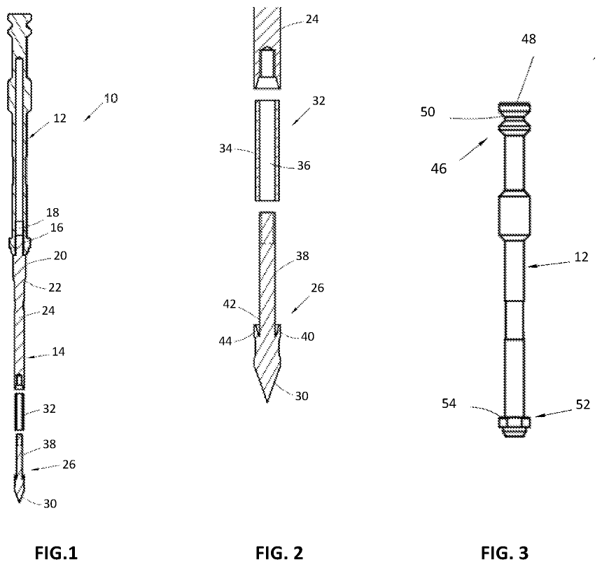

Referring to FIG. 1, a sampling probe 10 is now described to assist in the understanding of the invention, although it will be appreciated that the invention is not limited to use with any specific probe configuration. The sample probe 10 comprises an upper stem section 12 and lower stem section 14. The lower stem section 14 includes a threaded portion 16 that engages with a corresponding threaded section 18 of the upper stem section 12 to connect the lower stem section 14 to the upper stem section 12. The upper end 20 of the lower stem section 14 has a diameter consistent with the diameter of the upper stem section 12. The diameter of the lower stem section 14 reduces along its length at tapered section 22 to a reduced diameter lower end 24.

The lower end 24 includes a detachable tip section 26. The tip section 26 includes a shaft 38 and a tapered tip 30 at its distal end. A sleeve 32 is provided that is formed of a sorbent material. As shown in FIG. 2, the sleeve 32 is substantially cylindrical having a wall section 34 with a bore 36 extending therethrough. The bore 36 has a diameter substantially equal to the diameter of the shaft section 28. The sleeve 32 is therefore configured to fit over and receive the shaft 38 in a closely toleranced fit such there is substantially no gap between the inner surface of the bore 36 and the outer surface of the shaft 38. The sleeve 32 is described in further detail below.

The tip 30 is tapered to a point at its distal end for providing a tapered leading edge to assist insertion through the aperture of the septum of a sample vessel. The inner end of the tip 30 defines a first clamping surface 31. The inner end 38 includes an annular recess 40 extending longitudinally towards the distal end that is configured to receive one end of the sleeve 32. The recess 40 has an inner wall 42 that is contiguous with the outer surface of the shaft 38, and an outer wall 44. At the opening of the recess 40 the outer wall 44 is spaced radially outwards from the inner wall 42. The outer wall 44 is angled radially inwards towards the base of the recess 40 such that the recess 40 tapers to its base where the outer wall 44 and inner wall 42 meet. The lower end 24 also comprises a clamping surface 33 located at its distal end 35.

Referring to FIG. 3, the upper stem section 12 of the sampling probe 10 is now described. The upper stem section 12 is cylindrical and includes at its upper end 46 a connector portion 48 having a greater diameter than the main shaft of the upper stem section 12. The connector portion 48 includes a circumferentially extending bevelled engagement channel 50 of reduced diameter that is configured to receive a corresponding latching element of a z axis actuator of a robotic arm. The latching element may be a spring-loaded ball catch or any other suitable element that is configured to extend into and engage with the channel 50 to vertically retain the probe 10.

The upper stem section 12 includes a locking section 52. The locking section 52 includes a radially extending shoulder section 54 having a diameter greater than the main body of the upper stem section 12. The shoulder 54 is arranged to receive a latch plate or similar locking element. In use a latch plate is arranged such that when the probe 10 is received at a location where it is required to vertically lock the probe 10 in position, the latch plate is vertically aligned such that the lower surface of the latch plate is vertically aligned with the upper surface of the shoulder 54.

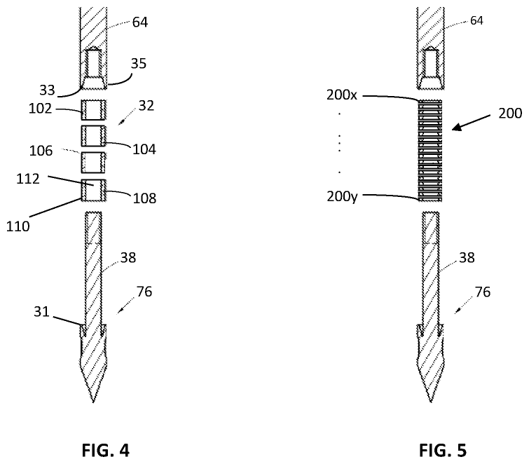

Referring to FIG. 4, the sorbent sleeve 32 is formed of a plurality of sorbent elements 102, 104, 106 and 108, which are shown in exploded form for illustrative purposes. Each sorbent element 102, 104, 106 and 108 is substantially cylindrical comprising a wall section 110 and bore 112 extending longitudinally within the outer wall 110. The sorbent elements 102, 104, 106 and 108 are punched or otherwise formed from a sheet of sorbent material. Each of the sorbent elements 102, 104, 106 and 108 define a cylindrical length. Each bore 110 has a diameter substantially equal to the diameter of the shaft section 38. The sorbent elements 102, 104, 106, 108 are therefore configured to fit over and receive the shaft 38 in a closely toleranced fit.

The sorbent elements 102, 104, 106 and 108 are each inserted onto the shaft 28 in series and when received on the shaft combined to form the sorbent sleeve 32. Alternatively, the sorbent elements 102, 104, 106 and 108 may be pre-assembled to form the sleeve 32 and inserted onto the shaft 38 in a single step.

As the detachable tip section 26 is threaded into the lower stem section 14 the sorbent elements 102, 104, 106, 108 are longitudinally compressed between the first clamping surface 31 and the second clamping surface 33. The probe 10 may include flat sections (not shown) on the detachable tip section 26 and the lower stem section 24, such that the detachable tip section 26 can be tightened into the lower stem section 64 and body to a pre-defined torque using for example a pair of spanners, thereby generating axial compression of the sorbent sleeve 32. The uppermost sorbent element 102 has an axial outer end surface 112 that faces the second clamping surface 33 and the lowermost sorbent element 108 has an axial outer end surface 114 that faces the first clamping surface 31. Axial compression of the sleeve 32 between the first and second clamping surfaces 31,33 creates a radial seal between the outer end surface 112 of sorbent element 102 in contact with the second clamping surface 33 of the lower stem section 24 and a separate radial seal between the outer end surface 114 of the sorbent element 108 in contact with the first sealing surface 31 defined within the recess 90. Further, as these exterior sorbent elements 102, 108 form seals with the clamping surfaces 31,33, the inner axial faces of the sorbent elements 102, 104, 106 and 108 seal against each other.

The compression applied to the sorbent elements 102, 104, 106 and 108 causes them to seal against each other in such a way that liquid ingress between the sorbent elements 102, 104, 106 and 108 is prevented. The sorbent elements 102, 104, 106 and 108 therefore effectively form a continuous, unbroken and watertight sleeve. Similarly, the axial end surfaces 112,114 create a watertight seal with the clamping surfaces 31,33 that prevents water ingress into the bore 36 of the sleeve 32. Preventing liquid ingress avoids the sample becoming entrapped within or behind the sleeve 32. Such entrapped liquid is challenging to remove during cleaning stages and may cause onward sample contamination resulting in the analysis of unintended analytes.

In an alternative embodiment, the sorbent elements sorbent elements 102, 104, 106 and 108 could be bonded together instead of axially compressed, for example by plasma bonding. The sleeve 32 could similarly be bonded to the probe, thereby obviating the requirement for a clamping arrangement to creating a compressional sealing force.

Conventionally, a sorbent probe carries a single sorbent material specified for but constrained to a specific range of analytes. As such, multiple probes and/or analyses have been required to extract a wider or the widest range of analytes from a single sample. The use of multiple sorbent elements 102, 104, 106 and 108 to create a laminate sleeve enables the sleeve to be formed of multiple sorbent materials. One or more of the sorbent elements 102, 104, 106 and 108 may be formed from a different sorbent material to one or more of the other sorbent elements 102, 104, 106 and 108. Each of the sorbent elements 102, 104, 106 and 108 may therefore be selected to comprise a sorbent material selected to extract required analytes. The sleeve 32 may therefore be configured to extract multiple analytes (or the widest range of analytes, or a constrained range of target analytes) in a single analysis, obviating the requirement to replicate analysis with multiple probes and therefore significantly reducing analysis time.

The sorbent elements 102, 104, 106, 108 are formed having a common outer diameter to ensure a smooth and axially aligned outer surface. The outer diameter of the sorbent elements 102, 104, 106, 108 is selected to be less than or equal to that of the tip 30 of the probe. This ensures that as the tapered tip 30 passes through a sample vial seal the sorbent material does not engage with the seal. This mitigates the risk of distortion of the sample vial seal as the probe passes through it, which can damage the sample vial seal and will reduce the lifespan of the sorbent elements themselves. Also, good alignment and a smooth outer surface further limits the risk of sample ingress between the sorbent elements.

Referring to FIG. 5, in an alternative embodiment the sorbent sleeve 200 incorporates a plurality of sorbent elements 200x-200y of substantially reduced axial length compared to the sorbent arrangement 32 disclosed in FIG. 4. Beneficially by reducing the length of said sorbent elements 200x-200y, an increased number and/or variety of said sorbent elements can be located on the shaft 78.

The sorbent elements 102, 104, 106 and 108 are formed from a sheet of sorbent material having a thickness corresponding to the axial length of each sorbent element 102, 104, 106 and 108. The sorbent elements 102, 104, 106 and 108 may be punched, die cut or otherwise formed out of the precursory sheet. The sorbent elements 102, 104, 106 and 108 are formed having a shape corresponding to the cross-sectional shape of the sorbent sleeve or other sorbent member to be formed by the sorbent elements 102, 104, 106 and 108.

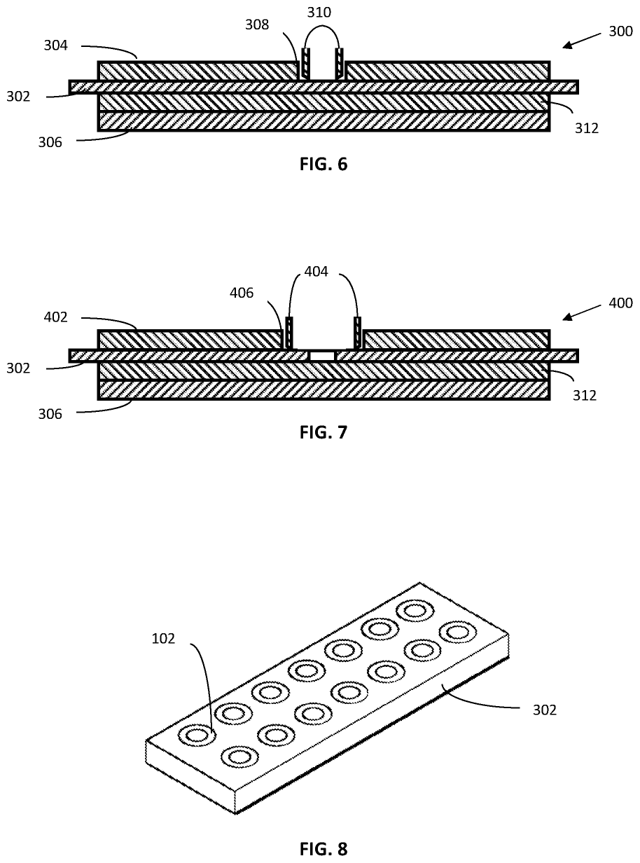

In an aspect of the invention, a method of forming a sorbent device, such as a sorbent sleeve, comprises providing a sheet of sorbent material 302, as shown in FIG. 6. In a first cutting procedure, a punching assembly 300 comprises a sheet of sorbent material 302 clamped between a first upper template 304 and a baseplate 306. Clamping the sorbent sheet 302 in this manner restrains the material and minimised movement as the material, resulting in a more consistent and cleaner cut. The first upper template 304 comprises a first plurality of spaced holes 308 with a diameter corresponding to that of a first punch tool 310. The first punch tool 310 is a circular hole punch, although other shapes may be used. The first punch tool 310 is inserted into each of the first spaced holes 308 in turn to make cuts through the sheet 302, towards the baseplate 306. A sacrificial material layer 312, for example PVC, is placed between the sorbent sheet 302 and baseplate 306 to ensure that the first punch 310 passes completely through the sorbent sheet 302.

Following the first cutting procedure, the sorbent material 302 is then subject to a second cutting procedure. As shown in FIG. 7, the first upper template 304 is replaced by a second upper template 404, which contains a second plurality of spaced holes 408 with a diameter greater than the first plurality of spaced holes 308 and corresponding to a second punch 410 which is also circular hole punch. The second plurality of spaced holes 406 are located in the second upper template 404 in locations corresponding to the holes of the first upper template 304, such that when the second upper template 404 is placed over the sheet 302, the second plurality of spaced holes 408 are concentric with the holes cut in the sheet 302 in the first punching operation. The second punch 410 is inserted into each of the second spaced holes 408 in turn to make cuts through the sheet 302 diametrically outwards of the first holes.

As a result of the first and second cutting procedures, the sorbent material 302 is mechanically cut in a manner that produces a series of cylindrical sorbent elements 102, having an annular cross section with central longitudinal bores extending axially therethrough, as shown in FIG. 8. The sorbent elements 102 are then separated from the sheet 302 and the core material within the bore is removed. The sorbent elements 102 are then post processed to enable their use with a sorbent probe. The sorbent elements are mounted on one or more treatment rods and subjected to chemical cleaning and thermal desorption. Chemical cleaning ensures all residue on the surface of the sorbent elements is removed whilst thermal desorption removes any analytes that may have been unintentionally adsorbed into the sorbent elements during manufacture. This results in a chemically inert sorbent.

The above-described method of forming a sorbent device, such as a sorbent sleeve, enables a 3 dimensional sorbent device to be formed from sheet sorbent material rather than necessitating the use of tubular sorbent material. This substantially expands the potential sorbent materials that can be implemented in a cost-effective manner. Further, custom sorbent materials from which the sleeve is formed can be manufactured in sheet/film form in a manner that wastes little material, even over short manufacturing runs, as compared for example to methods such as extrusion. Custom sorbent materials, such as 3-phase materials, or higher order compositions, can be implemented. Sorbent elements can be manufactured from sorbent materials that include, but are not limited to, polymers, co-polymers and additive loaded co-polymers/polymers.

Both hydrophilic and hydrophobic sorbent elements 102, 104, 106 and 108 may be incorporated in the same sleeve element 32 and mounted to a probe, enabling extraction of a wide range of analytes from the same sample, whilst still ensuring only target analytes are captured. One example of hydrophobic sorbent would be PDMS and one example of a hydrophilic sorbent would be a carbon-loaded co-polymer.

Additive materials may be dispersed within the sorbent material during the formation of the sorbent sheets. The efficacy of a sorbent device is improved if the additive is in close contact with the sample in use. Typical manufacturing methods such as extrusion into tubes result in additive material being embedded within the device below an outer layer of sorbent substrate. By forming the sheet material and then mechanically cutting the sorbent material from a region within the sheet, loaded additives (such as carbon black) are presented at the cut surfaces, improving contact with the sample into which the sorbent material is exposed. This results in improved efficiency over existing extruded sorbent tubes, which inherently have little additive exposed.

Beneficially, by post processing the sorbent elements prior to assembling them in a sorbent arrangement the surface area exposed to treatment is increased. This improves the efficiency of both the chemical cleaning and thermal desorption and minimises carry-over of unintended analytes to the final sorbent probes.

1. A sorbent device for sorptive sampling comprising a body having a laminate structure formed of a plurality of layers of sorbent material.

2. The sorbent device according to claim 1, wherein the body is elongate having a width and a longitudinal axis and the plurality of layers are axially arranged.

3. The sorbent device according to claim 2, wherein the body is cylindrical.

4. The sorbent device according to claim 3, wherein the body comprises an axially extending bore for receiving the shaft of a probe.

5. The sorbent device according to claim 1, wherein one or more of the plurality of layers is formed from a sorbet material that is different to the sorbent material of one of more of the other plurality of layers.

6. A sorbent probe comprising a shaft and the sorbent device according to claim 1 secured to said shaft.

7. The sorbent probe according to claim 6, wherein the sorbent device is formed as a sleeve having an axially extending bore where the sleeve is received around a portion of the shaft.

8. The sorbent probe according to claim 7, wherein the sorbent device has axially opposed first and second ends and the sorbent probe comprises first and second clamping elements located respectively at the first and second ends of the sorbent device operative to clamp and axially compress the plurality of layers of the sorbent device.

9. The sorbent probe according to claim 8, wherein the probe includes a piercing tip having a first outer diameter and the sorbent device has a second outer diameter that is less than or equal to the first diameter.

10. A method of forming a sorbent device comprising:
providing one or more sheets of sorbent material;
cutting a plurality of sorbent elements from said one or more sheets of sorbent material;
assembling said plurality of sorbent elements to form a laminate structure having a series of layers defined by said plurality of sorbent elements.

11. The method according to claim 6, wherein each of said sorbent elements have the same shape.

12. The method according to claim 6, wherein each of said sorbent elements is annular and the plurality of sorbent elements are assembled to form a cylinder having an axially extending bore.

13. The method according to claim 8, wherein the plurality of sorbent elements is formed from a plurality of sheets of sorbent material and one or more of the plurality of sheets is formed from a sorbet material that is different to the sorbent material of one of more of the other plurality of sheets, and the sorbent elements are assembled such that one or more of the plurality of sorbent elements is formed from a sorbet material that is different to the sorbent material of one of more of the other plurality of sorbent elements.

14. The method according to claim 6, wherein the plurality of sorbent elements are cut from the one or more sorbent sheets by a punching operation.

15. A method of forming a sorbent sampling probe comprising:
forming a plurality of sorbent elements according to the method of claim 8;
inserting said plurality of sorbent elements onto a shaft of a sample probe having a longitudinal axis to form a laminate sleeve; and
securing said sorbent elements on said shaft.

16. The method according to claim 11, further comprising applying an axially compressive force to the sleeve to clamp the sorbent elements together and secure them on the shaft.

17. The method according to claim 15, further comprising selecting a plurality of sorbent elements formed of different sorbent materials to wherein the sorbent materials are selected based on target analytes.
